(19) United States
(12) Patent Application Publication
(10) Pub. No.: US 2023/0100038 A1
(43) Pub. Date: Mar. 30, 2023

(54) COMBINED SOFT AND STIFF-STRING TORQUE AND DRAG MODEL

(71) Applicant: LANDMARK GRAPHICS CORPORATION, Houston, TX (US)

(72) Inventors: Robello Samuel, Cypress, TX (US); Yuan Zhang, Missouri City, TX (US)

(73) Assignee: LANDMARK GRAPHICS CORPORATION, Houston, TX (US)

(21) Appl. No.: 17/054,432

(22) PCT Filed: Jan. 2, 2020
(86) PCT No.: PCT/US2020/012023

§ 371 Date: Nov. 10, 2020

(51) Int. Cl. E21B 47/007; E21B 44/04; E21B 7/06

(52) U.S. Cl. CPC E21B 47/007; E21B 44/04; E21B 7/06; E21B 2200/20

(57) ABSTRACT

Aspects of the disclosed technology provide techniques for determining frictional forces bearing on a downhole drill string. In some implementations, a method of the disclosed technology can include steps for segmenting a plurality of continuous nodes of the drilling string into a first segment and a second segment, computing a first set of values corresponding with one or more nodes in the first segment using a first model, computing a second set of values corresponding with one or more nodes in the second segment using a second model, and determining a torque of the drill string based on the first set of values and the second set of values. In some aspects, the method can further include steps for determining a drag force on the drill string based on the first set of values and the second set of values. Systems and machine-readable media are also provided.

### TECHNICAL FIELD

The present disclosure relates generally to methods and apparatuses used in drilling wellbores for hydrocarbon production. More specifically, the disclosure relates to methods and systems for providing accurate wellbore placement by improving the accuracy of mathematical modeling of wellbore and drilling operations, including the estimation of torque and drag on a drill string.

### BACKGROUND

To obtain hydrocarbons such as oil and gas, wellbores are typically drilled by rotating a drill bit that is attached at the end of the drill string. Modern drilling systems frequently employ a drill string having a bottom hole assembly and a drill bit at an end thereof. The drill bit is rotated by a downhole motor of the bottom hole assembly and/or by rotating the drill string. Pressurized drilling fluid is pumped through the drill string to power the downhole motor, provide lubrication and cooling to the drill bit and other components, and carry away formation cuttings.

A large proportion of drilling activity involves directional drilling, e.g., drilling deviated, branch, and/or horizontal wellbores. In directional drilling, wellbores are usually drilled along predetermined paths in order to increase the hydrocarbon production. As the drilling of the wellbore proceeds through various formations, the downhole operating conditions may change, and the operator must react to such changes and adjust parameters to maintain the predetermined drilling path and optimize the drilling operations. The drilling operator typically adjusts the surface-controlled drilling parameters, such as the weight on bit, drilling fluid flow through the drill string, the drill string rotational speed, and the density and/or viscosity of the drilling fluid, to affect the drilling operations.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1A is a schematic diagram of an example drilling environment, in accordance with various aspects of the subject technology.

FIG. 1B is a schematic diagram of an example wireline logging environment, in accordance with various aspects of the subject technology.

FIG. 2 is a cut-away view of a wellbore environment that includes a downhole drill string including multiple continuous nodes.

FIG. 3 conceptually illustrates the combined use of different torque and drag models in the analysis of drill string force properties, according to some aspects of the disclosed technology.

FIG. 4 is a process for determining torque and/or drag on a drill string using a multi-model calculation, according to some aspects of the disclosed technology.

FIG. 5 is a block diagram of an example control system configured to perform multi-model force calculations, according to some aspects of the disclosed technology.

FIG. 6 is a schematic diagram of an example system embodiment.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

Additional features and advantages of the disclosure will be set forth in the description which follows, and in part will be obvious from the description, or can be learned by practice of the principles disclosed herein. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Drilling operations are often conducted in accordance with one or more drilling or pre-drilling models of the subterranean conditions along the intended path of the wellbore. The following is a non-exclusive list of some of the variables various models may take into consideration: Wellbore properties, such as wellbore geometry, temperature and diameter versus the wellbore depth; friction, including dynamic and static friction coefficients throughout the wellbore; pressures, viscosities, densities, and flow rates of the fluids inside and outside of the drill string; material properties, such as strength and elastic modulus of the drill string components; inside and outside diameters along the length of the drill string; torque and force applied at the surface; tool properties, such as the length, outside diameter, stiffness, internal diameter, and flow restrictions in the tools being conveyed by the drill string, if any; and finally, the axial and rotational speeds of drill string and bit.

Computer-based models are sometimes used to calculate quantities such as the forces, stresses, torques, stretch, etc. associated with the drill string or other conveyances, such as coiled tubing, etc. Selection of the ideal model can depend on various factors; for example, soft-string, stiff-string, and finite element analysis (FEA) methods are different models that can be used to calculate torque and drag resulting from contact between the drill string and side walls of the wellbore.

Torque-drag modeling is commonly used to determine when the drill string is approaching a limit at which it may break or buckle; how much force, either tension or in compression, the drill string can apply at its downhole end; how much torque is being applied at the downhole end given a certain torque applied at surface; how much twist is in the drill string between the surface and the downhole end; the torsional and axial dynamic frequencies for stick-slip-type movements; and how much the drill string length will stretch or compress due to axial forces, twisting, temperature, pressure, and helical buckling, for example.

Understanding changes in drill string length can help to accurately calculate the depth of the drill string or the location of a tool it may be conveying. Similarly, knowledge of the amount of twist in a drill string can help ensure accurate tool face placement. For these reasons, mathematical simulations using torque-drag computer modeling programs provide useful data that is not available by simply monitoring drill string torque and hook loads at the surface.

However, not all torque and drag models are equally suitable in the same applications. For example, calculations using soft-string models are typically faster than those of stiff-string and FEA models. However, soft-string modeling omits considerations of element (string) stiffness, as well as the influence of hole size and radial clearance, and is therefore not suitable for applications in which the drill string is floating, or otherwise out of contact with the wellbore wall. Stiff-string and FEA methods, by contrast, are typically more accurate because a greater number of variables are considered, however, these models are computationally expensive, thereby limiting their suitability for real-time drilling and/or use in drilling automation.

Aspects of the disclosed technology, address the foregoing limitations of available torque-drag modeling by providing methodologies for using multiple models to compute an overall torque and/or drag on a drill string. In some embodiments, two or more different models may be used. For example, soft-string and stiff-string modeling techniques may be used (in combination) to compute torque-drag over different sections (segments) of the drill string. However, those of skill in the art will understand that the computational methods of the disclosed embodiments are not limited to the use of two model types, and that additional and/or other modeling techniques may be applied, without departing from the scope of the disclosed technology.

In some aspects, different model types (e.g., soft-string, stiff-string, and/or FEA) can be selectively applied to compute torque-drag parameters across different segments of a drill string. As such, methods of the disclosed technology provide mixed-modeling techniques that optimally utilize soft-string, stiff-string and/or FEA models in the calculation of torque and/or drag forces on a drill string. As discussed in further detail below, by optimally matching model types with different drill string segments (e.g., based on segment characteristics), the disclosed techniques can advantageously balance the tradeoffs between computational speed and accuracy, thereby enabling real-time torque-drag modeling necessary to facilitate drilling automation.

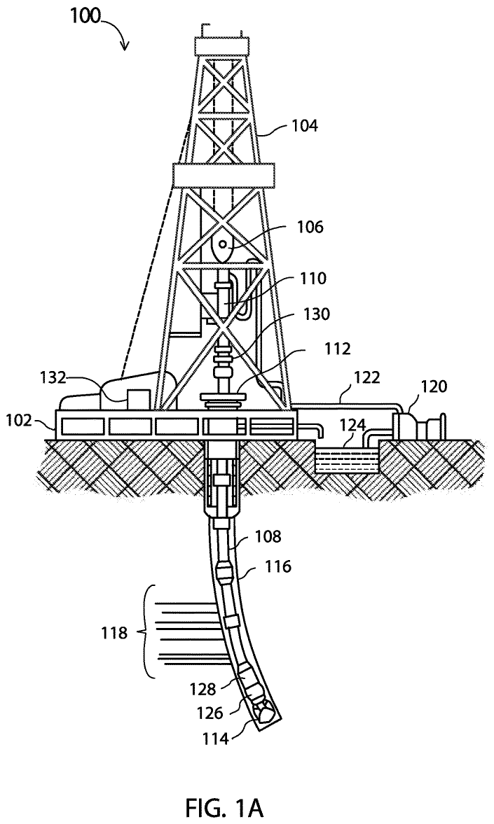

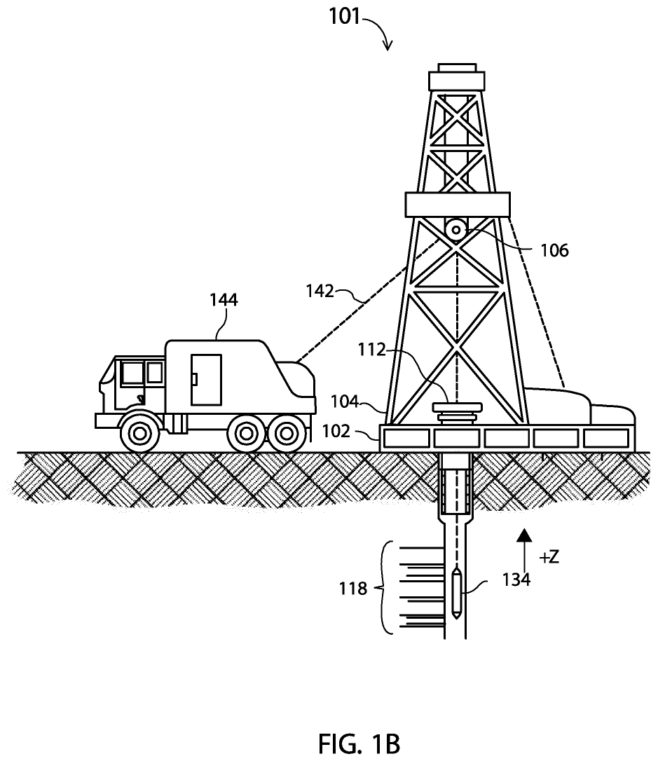

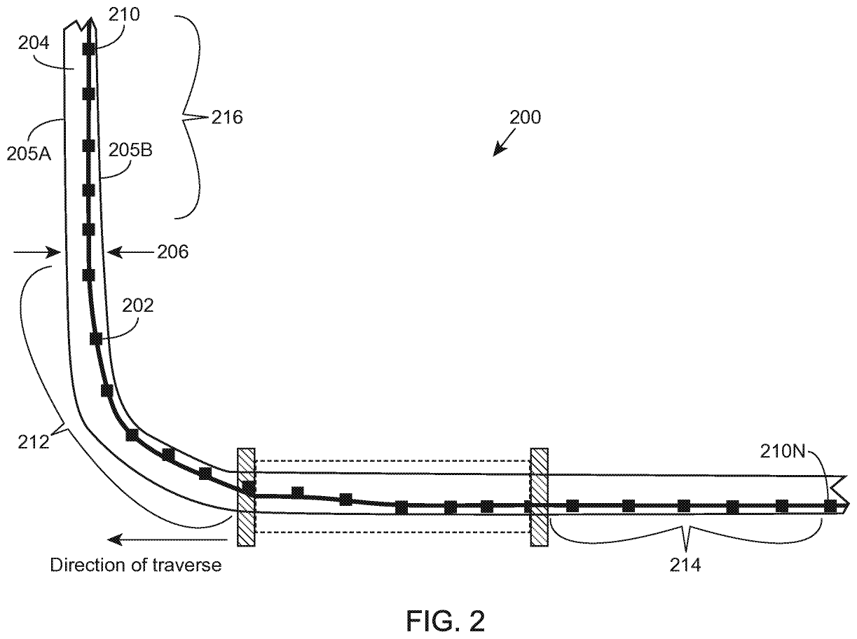

The disclosure now turns to FIGS. 1A-B, and FIG. 2 to provide a brief introductory description of the larger systems that can be employed to practice the concepts, methods, and techniques disclosed herein. A more detailed description of the methods and systems for implementing the improved semblance processing techniques of the disclosed technology will then follow.

FIG. 1A shows an illustrative drilling environment 100. Within environment 100, drilling platform 102 supports derrick 104 having traveling block 106 for raising and lowering drill string 108. Kelly 110 supports drill string 108 as it is lowered through rotary table 112. Drill bit 114 is driven by a downhole motor and/or rotation of drill string 108. As bit 114 rotates, it creates a borehole 116 that passes through various formations 118. Pump 120 circulates drilling fluid through a feed pipe 122 to kelly 110, downhole through the interior of drill string 108, through orifices in drill bit 114, back to the surface via the annulus around drill string 108, and into retention pit 124. The drilling fluid transports cuttings from the borehole into pit 124 and aids in maintaining borehole integrity.

Downhole tool 126 can take the form of a drill collar (i.e., a thick-walled tubular that provides weight and rigidity to aid the drilling process) or other arrangements known in the art. Further, downhole tool 126 can include various sensor and/or telemetry devices, including but not limited to: acoustic (e.g., sonic, ultrasonic, etc.) logging tools and/or one or more magnetic directional sensors (e.g., magnetometers, etc.). In this fashion, as bit 114 extends the borehole through formations 118, the bottom-hole assembly (e.g., directional systems, and acoustic logging tools) can collect various types of logging data. For example, acoustic logging tools can include transmitters (e.g., monopole, dipole, quadrupole, etc.) to generate and transmit acoustic signals/waves into the borehole environment. These acoustic signals subsequently propagate in and along the borehole and surrounding formation and create acoustic signal responses or waveforms, which are received/recorded by evenly spaced receivers. These receivers may be arranged in an array and may be evenly spaced apart to facilitate capturing and processing acoustic response signals at specific intervals. The acoustic response signals are further analyzed to determine borehole and adjacent formation properties and/or characteristics.

For purposes of communication, a downhole telemetry sub 128 can be included in the bottom-hole assembly to transfer measurement data to surface receiver 130 and to receive commands from the surface. In some implementations, mud pulse telemetry may be used for transferring tool measurements to surface receivers and receiving commands from the surface; however, other telemetry techniques can also be used, without departing from the scope of the disclosed technology. In some embodiments, telemetry sub 128 can store logging data for later retrieval at the surface when the logging assembly is recovered. These logging and telemetry assemblies consume power, which must often be routed through the directional sensor section of the drill string, thereby producing stray EM fields which interfere with the magnetic sensors.

At the surface, surface receiver 130 can receive the uplink signal from downhole telemetry sub 128 and can communicate the signal to data acquisition module 132. Module 132 can include one or more processors, storage mediums, input devices, output devices, software, and the like as described in further detail below. Module 132 can collect, store, and/or process the data received from tool 126 as described herein.

At various times during the drilling process, drill string 108 may be removed from the borehole as shown in example environment 101, illustrated in FIG. 1B. Once drill string 108 has been removed, logging operations can be conducted using a downhole tool 134 (i.e., a sensing instrument sonde) suspended by a conveyance 142. In one or more embodiments, the conveyance 142 can be a cable having conductors for transporting power to the tool and telemetry from the tool to the surface. Downhole tool 134 may have pads and/or centralizing springs to maintain the tool near the central axis of the borehole or to bias the tool towards the borehole wall as the tool is moved downhole or uphole.

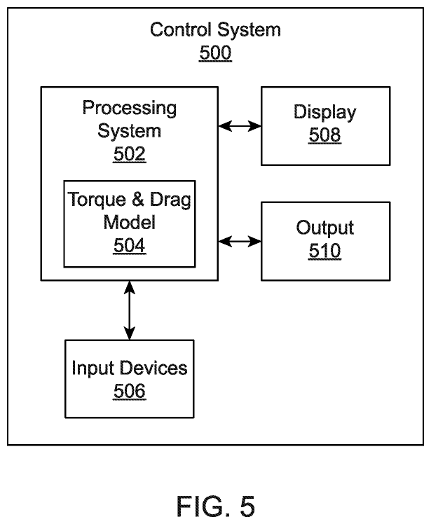

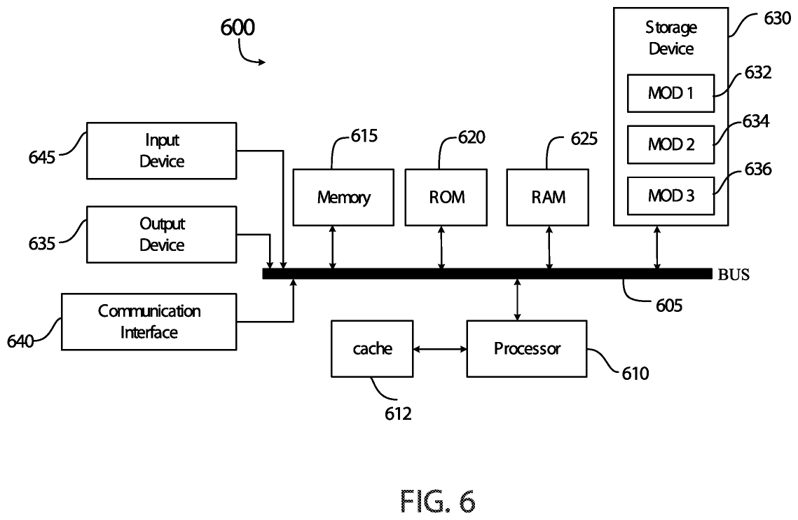

Downhole tool 134 can include various directional and/or acoustic logging instruments that collect data within borehole 116. A logging facility 144 includes a computer system, such as those described with reference to FIGS. 5 and 6, discussed below. In one or more embodiments, the conveyance 142 of downhole tool 134 can be at least one of wires, conductive or non-conductive cable (e.g., slickline, etc.), as well as tubular conveyances, such as coiled tubing, pipe string, or downhole tractor. Downhole tool 134 can have a local power supply, such as batteries, downhole generator and the like. When employing non-conductive cable, coiled tubing, pipe string, or downhole tractor, communication can be supported using, for example, wireless protocols (e.g. EM, acoustic, etc.), and/or measurements and logging data may be stored in local memory for subsequent retrieval.

Although FIGS. 1A and 1B depict specific borehole configurations, it is understood that the present disclosure is equally well suited for use in wellbores having other orientations including vertical wellbores, horizontal wellbores, slanted wellbores, multilateral wellbores and the like. While FIGS. 1A and 1B depict an onshore operation, it should also be understood that the present disclosure is equally well suited for use in offshore operations. Moreover, the present disclosure is not limited to the environments depicted in FIGS. 1A and 1B, and can also be used in either logging-while-drilling (LWD) or measurement while drilling (MWD) operations.

FIG. 2 is a cut-away view of a wellbore environment 200 that includes drill string 202 having multiple continuous nodes 210₁-210_{N}. Nodes 210₁-210_{N} can represent nodes of a pipe or tool joint that are continuously repeated across the substantial length of drill string 202. In the example of environment 200, drill string 202 is shown to curve (dog-leg) within wellbore 204, such that some of the nodes are in contact with a low-side of wellbore wall 205A, whereas other nodes are in contact with a high-side of wellbore wall 205B, and some of the nodes are floating. That is, the pipe-to-hole boundary 206 varies between different nodes, depending on their location/orientation within wellbore 204. Because the suitability of different torque-drag models can vary based on node characteristics, a single model may not be optimally applied in the calculation of torque-drag values across all nodes 210₁-210_{N}. As such, drill string 202 can be segmented by grouping nodes sharing similar characteristics. In the example of environment 200, drill string 202 is divided into segments 216, 212, and 214, each of which corresponds to a group of nodes similarly situated in wellbore 204. By segmenting drill string 202 in node segments, different torque-drag models can be applied to different segments, depending on the corresponding segment characteristics.

In some aspects, segmenting can be performed based on user defined rules or parameters. For example, user defined inclination thresholds can be defined whereby positional deviations of the drill string exceeding the threshold are segmented into different segments. By way of example, user defined parameters may be used to segment portions of the drill string that dogleg more than 15 degrees per 100 feet of length, for example, indicating that the corresponding nodes may be out of contact with wellbore walls 205.

In other aspects, segmentation may be informed using computations resulting from the application of one or more models across all nodes 210₁-210_{N} of drill string 202. For example, a stiff-string model may be applied to identify locations (nodes) along drill string 202 where the stiff-string model is sub-optimal By knowing the node location within the path of the wellbore 204, such calculations can be used to later segment drill string 202 as it is repositioned, e.g., by running in-hole.

Once drill string 202 is segmented, different models can be applied to determine torque-drag characteristics across different segments. In the example of drill string 202, a soft-string model may be applied to segments 216 and 214, whereas stiff-string (or FEA) modeling may be applied to the floating nodes corresponding with segment 212. As discussed in further detail below, torque-drag calculations using mixed modeling techniques can require resolution of node characteristics, for example, to interpolate values derived from the separate models so that torque-drag contributions of each node can be correctly integrated across the string length.

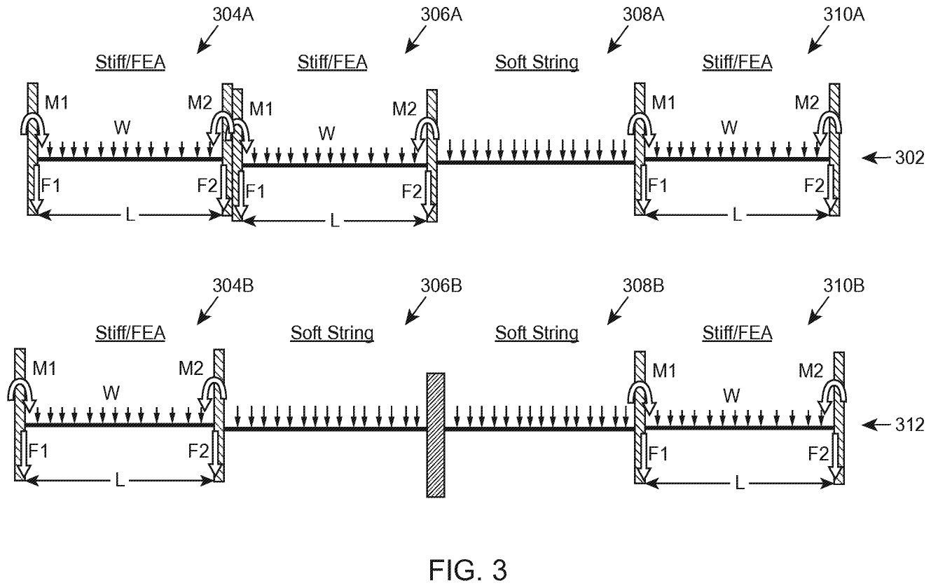

FIG. 3 conceptually illustrates the combined use of different torque and drag models in the analysis of drill string force properties, according to some aspects of the technology. In the example of FIG. 3, initial modeling calculations 302 are represented graphically as drill string segments 304A, 306A, 308A, and 310A, along with the corresponding model used to perform the calculation. For example, segments 304A, 306A, and 310A correspond with a stiff-string (or FEA) model, whereas segment 308A corresponds with a soft-string model. By analyzing the force and/or displacement values for each node within the various segments, it can be determined what segments (if any) should be modeled using a different model type than what was initially used. In the example of FIG. 3, subsequent modeling calculations 312, correspond with segments 304B, 306B, 308B, and 310B. In this example, stiff-string (or FEA) modeling applied to segment 306A is revised to a soft-string model (segment 306B). As such, segments 306B and 308B can be effectively merged based on common characteristics shared by an intervening node.

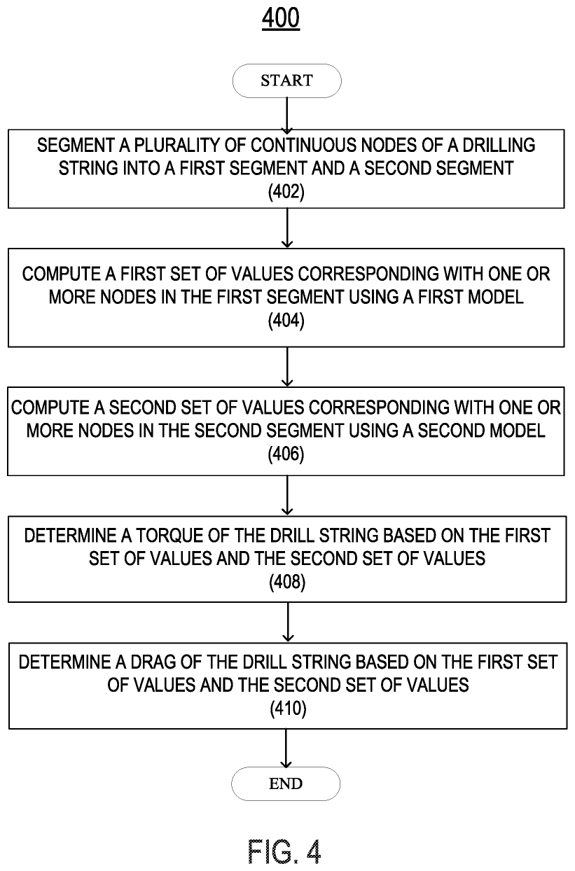

FIG. 4 is a process 400 for determining torque and/or drag on a drill string using a multi-model calculation, according to some aspects of the disclosed technology. Process 400 begins with step 402 in which a drill string is segmented into multiple segments, for example, into a first and second segments. As discussed above, segmentation can be based on user defined parameters, or based on calculated node characteristics determined using one or more torque-drag models, such as a stiff-string model.

In step 404, a first set of values are computed using a first model, wherein the values correspond with one or more nodes in the first segment. In some aspects, computed node values may include force and or drag values for each node in the drill string. Additionally, the computed node values may include other node characteristics, such as a distance from the wellbore wall. By way of example, the first segment may include nodes that are abutting the wellbore wall, such as the nodes included in segment 214, discussed above with respect to FIG. 2. As such, the nodes in the first segment can be modeled using a soft-string model.

In step 406, a second set of values are computed using a second model, wherein the values correspond with one or more nodes in the second segment. Similar to step 404, the second set of values can represent characteristics of one or more nodes belonging to a different segment of the drill string, such as, segment 202, discussed above with respect to FIG. 2. As such, the model used to compute node characteristics for the second segment can be different from the model used to compute characteristics for nodes in the first segment. For example, the second model can include a stiff-string and/or FEA model, which is better suited for determining torque and/or drag characteristics for floating segments of the drill string.

In step 408, a torque of the drill string is computed based on the first set of values and the second set of values. As discussed above, calculations using values resulting from the application of different models can require the resolution of boundary nodes. In some aspects, the resolution of boundary nodes can be performed automatically, for example, by comparing force, drag and/or wellbore-displacement characteristics amongst various boundary points to identify common (overlapping) nodes in the various value sets.

In step 410, determining a drag force on the drill string based on the first set of values and the second set of values. In some aspects, steps 408 and 410 can be performed together, i.e., torque and drag calculations can be performed as one step. Alternatively, only torque and/or only drag calculations may be performed, depending on the desired implementation. It is understood that the foregoing descriptions of the use of two different models to compute node values for two different segments of drill string are intended to be illustrative, and not limiting in nature. Those of skill in the art will recognize that similar (or different) models may be used to compute node value characteristics for three or more drill string segments, without departing from the scope of the disclosed technology.

FIG. 5 is a block diagram of an example control system 500 that can be configured to apply multiple models in the calculation of drill string node characteristics, according to some aspects of the disclosed technology. Depending on the desired implementation, control system 500 may be implemented either on the surface of a drilling operation, or down-hole. In some aspects, control system 500 may be implemented using a combination of distributed hardware and/or firmware/software that resides on both the surface and down-hole.

As illustrated control system 500 comprises a processing system 502 that includes a torque and drag module 504. Additionally, to facilitate the receipt and output/display of data, control system 500 can include input devices 506, output 510, and/or display 508.

As discussed above, torque and drag module 504 can be configured to compute torque and drag forces on a drill string, or on portions of a drill string, for example, using different torque-drag model types. By implementing a hybrid calculation approach to torque-drag modeling, control system 500 can optimize speed and accuracy necessary for performing real-time modeling and necessary to enable drilling automation.

FIG. 6 illustrates an exemplary computing system 700 for use with example tools and systems (e.g., tool 126). The more appropriate embodiment will be apparent to those of ordinary skill in the art when practicing the present technology. Persons of ordinary skill in the art will also readily appreciate that other system embodiments are possible.

Specifically, FIG. 6 illustrates system architecture 600 wherein the components of the system are in electrical communication with each other using a bus 605. System architecture 600 can include a processing unit (CPU or processor) 610, as well as a cache 612, that are variously coupled to system bus 605. Bus 605 couples various system components including system memory 615, (e.g., read only memory (ROM) 620 and random access memory (RAM) 625), to processor 610. System architecture 600 can include a cache of high-speed memory connected directly with, in close proximity to, or integrated as part of the processor 610. System architecture 600 can copy data from the memory 615 and/or the storage device 630 to the cache 612 for quick access by the processor 610. In this way, the cache can provide a performance boost that avoids processor 610 delays while waiting for data. These and other modules can control or be configured to control the processor 610 to perform various actions. Other system memory 615 may be available for use as well. Memory 615 can include multiple different types of memory with different performance characteristics. Processor 610 can include any general-purpose processor and a hardware module or software module, such as module 1 (632), module 2 (634), and module 3 (636) stored in storage device 630, configured to control processor 610 as well as a special-purpose processor where software instructions are incorporated into the actual processor design. Processor 610 may essentially be a completely self-contained computing system, containing multiple cores or processors, a bus, memory controller, cache, etc. A multi-core processor may be symmetric or asymmetric.

To enable user interaction with the computing system architecture 600, input device 645 can represent any number of input mechanisms, such as a microphone for speech, a touch-sensitive screen for gesture or graphical input, keyboard, mouse, motion input, and so forth. An output device 642 can also be one or more of a number of output mechanisms. In some instances, multimodal systems can enable a user to provide multiple types of input to communicate with the computing system architecture 600. The communications interface 640 can generally govern and manage the user input and system output. There is no restriction on operating on any particular hardware arrangement and therefore the basic features here may easily be substituted for improved hardware or firmware arrangements as they are developed.

Storage device 630 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 635, read only memory (ROM) 620, and hybrids thereof.

Storage device 630 can include software modules 632, 634, 636 for controlling the processor 610. Other hardware or software modules are contemplated. The storage device 630 can be connected to the system bus 605. In one aspect, a hardware module that performs a particular function can include the software component stored in a computer-readable medium in connection with the necessary hardware components, such as the processor 610, bus 605, output device 642, and so forth, to carry out various functions of the disclosed technology.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure. Claim language reciting “at least one of” a set indicates that one member of the set or multiple members of the set satisfy the claim.

### STATEMENTS OF THE DISCLOSURE

Statement 1: a computer-implemented method for determining frictional force on a downhole drilling string, the method comprising: segmenting a plurality of continuous nodes of the drilling string into a first segment and a second segment; computing a first set of values corresponding with one or more nodes in the first segment using a first model; computing a second set of values corresponding with one or more nodes in the second segment using a second model, and wherein the first model is different from the second model; and determining a torque of the drill string based on the first set of values and the second set of values.

Statement 2: the computer-implemented method of statement 1, further comprising: determining a drag force on the drill string based on the first set of values and the second set of values.

Statement 3: the computer-implemented method of any of statements 1-2, wherein segmenting the plurality of continuous nodes is performed based on user provided parameters.

Statement 4: the computer-implemented method of statements 1-3, wherein segmenting the plurality of continuous nodes is performed based on characteristics for one or more of the plurality of continuous nodes determined by a stiff-string model.

Statement 5: the computer-implemented method of statements 1-4, wherein the first model is a soft-string model.

Statement 6: the computer-implemented method of any of statements 1-5, wherein the second model is a stiff-string model.

Statement 7: the computer-implemented method of statements 1-6, wherein the second model utilizes finite element analysis.

Statement 8: a system for determining frictional forces bearing on a downhole drill string, the system comprising: one or more processors; and a non-transitory memory coupled to the one or more processors, wherein the memory comprises instruction configured to cause the processors to perform operations for: segmenting a plurality of continuous nodes of the drilling string into a first segment and a second segment; computing a first set of values corresponding with one or more nodes in the first segment using a first model; computing a second set of values corresponding with one or more nodes in the second segment using a second model, and wherein the first model is different from the second model; and determining a torque of the drill string based on the first set of values and the second set of values.

Statement 9: the system of statement 8, wherein the processors are further configured to perform operations comprising: determining a drag force on the drill string based on the first set of values and the second set of values.

Statement 10: the system of any of statements 8-9, wherein segmenting the plurality of continuous nodes is performed based on user provided parameters.

Statement 11: the system of any of statements 8-10, wherein segmenting the plurality of continuous nodes is performed based on characteristics for one or more of the plurality of continuous nodes determined by a stiff-string model.

Statement 12: the system of any of statements 8-11: wherein the first model is a soft-string model.

Statement 13: the system of statements 8-12, wherein the second model is a stiff-string model.

Statement 14: the system of statements 8-13, wherein the second model utilizes finite element analysis.

Statement 15: a tangible, non-transitory, computer-readable media having instructions encoded thereon, the instructions, when executed by a processor, are operable to perform operations for: segmenting a plurality of continuous nodes of a drilling string into a first segment and a second segment; computing a first set of values corresponding with one or more nodes in the first segment using a first model; computing a second set of values corresponding with one or more nodes in the second segment using a second model, and wherein the first model is different from the second model; and determining a torque of the drill string based on the first set of values and the second set of values.

Statement 16: the tangible, non-transitory, computer-readable media of statement 15, wherein the processors are further operable to perform operations comprising: determining a drag force on the drill string based on the first set of values and the second set of values.

Statement 17: the tangible, non-transitory, computer-readable media of any of statements 15-16, wherein segmenting the plurality of continuous nodes is performed based on user provided parameters.

Statement 18: the tangible, non-transitory, computer-readable media of any of statements 15-17, wherein segmenting the plurality of continuous nodes is performed based on characteristics for one or more of the plurality of continuous nodes determined by a stiff-string model.

Statement 19: the tangible, non-transitory, computer-readable media of statements 15-18, wherein the first model is a soft-string model or a stiff-string model.

Statement 20: the tangible, non-transitory, computer-readable media of statements 15-19, wherein the second model utilizes finite element analysis.

What is claimed is:

1. A computer-implemented method for determining frictional force on a downhole drilling string, the method comprising:
segmenting a plurality of continuous nodes of the drilling string into a first segment and a second segment;
computing a first set of values corresponding with one or more nodes in the first segment using a first model;
computing a second set of values corresponding with one or more nodes in the second segment using a second model, and wherein the first model is different from the second model; and
determining a torque of the drill string based on the first set of values and the second set of values.

2. The computer-implemented method of claim 1, further comprising:
determining a drag force on the drill string based on the first set of values and the second set of values.

3. The computer-implemented method of claim 1, wherein segmenting the plurality of continuous nodes is performed based on user provided parameters.

4. The computer-implemented method of claim 1, wherein segmenting the plurality of continuous nodes is performed based on characteristics for one or more of the plurality of continuous nodes determined by a stiff-string model.

5. The computer-implemented method of claim 1, wherein the first model is a soft-string model.

6. The computer-implemented method of claim 1, wherein the second model is a stiff-string model.

7. The computer-implemented method of claim 1, wherein the second model utilizes finite element analysis.

8. A system for determining frictional forces bearing on a downhole drill string, the system comprising:
one or more processors; and
a non-transitory memory coupled to the one or more processors, wherein the memory comprises instruction configured to cause the processors to perform operations for:
segmenting a plurality of continuous nodes of the drilling string into a first segment and a second segment;
computing a first set of values corresponding with one or more nodes in the first segment using a first model;
computing a second set of values corresponding with one or more nodes in the second segment using a second model, and wherein the first model is different from the second model; and
determining a torque of the drill string based on the first set of values and the second set of values.

9. The system of claim 8, wherein the processors are further configured to perform operations comprising:
determining a drag force on the drill string based on the first set of values and the second set of values.

10. The system of claim 8, wherein segmenting the plurality of continuous nodes is performed based on user provided parameters.

11. The system of claim 8, wherein segmenting the plurality of continuous nodes is performed based on characteristics for one or more of the plurality of continuous nodes determined by a stiff-string model.

12. The system of claim 8, wherein the first model is a soft-string model.

13. The system of claim 8, wherein the second model is a stiff-string model.

14. The system of claim 8, wherein the second model utilizes finite element analysis.

15. A tangible, non-transitory, computer-readable media having instructions encoded thereon, the instructions, when executed by a processor, are operable to perform operations for:
segmenting a plurality of continuous nodes of a drilling string into a first segment and a second segment;
computing a first set of values corresponding with one or more nodes in the first segment using a first model;
computing a second set of values corresponding with one or more nodes in the second segment using a second model, and wherein the first model is different from the second model; and
determining a torque of the drill string based on the first set of values and the second set of values.

16. The tangible, non-transitory, computer-readable media of claim 15, wherein the processors are further operable to perform operations comprising:
determining a drag force on the drill string based on the first set of values and the second set of values.

17. The tangible, non-transitory, computer-readable media of claim 15, wherein segmenting the plurality of continuous nodes is performed based on user provided parameters.

18. The tangible, non-transitory, computer-readable media of claim 15, wherein segmenting the plurality of continuous nodes is performed based on characteristics for one or more of the plurality of continuous nodes determined by a stiff-string model.

19. The tangible, non-transitory, computer-readable media of claim 15, wherein the first model is a soft-string model or a stiff-string model.

20. The tangible, non-transitory, computer-readable media of claim 15, wherein the second model utilizes finite element analysis.
